(19) United States
(12) Patent Application Publication
(10) Pub. No.: US 2026/0154643 A1
(43) Pub. Date: Jun. 4, 2026

(54) DYNAMIC VECTOR GUIDED DEPTH LIMITED GRAPH TRAVERSAL SYSTEM AND METHOD WITH ADAPTIVE RESOURCE OPTIMIZATION

(71) Applicant: ACCUDILIGENCE INC, St. Petersburg, FL (US)

(72) Inventors: Torpum Jannak, Spearfish, SD (US); Nanthawan Jannak, Spearfish, SD (US)

(21) Appl. No.: 19/455,495

(22) Filed: Jan. 21, 2026

Related U.S. Application Data
(63) Continuation-in-part of application No. 17/461,121, filed on Aug. 30, 2021, now abandoned.
(60) Provisional application No. 62/706,222, filed on Aug. 28, 2020.

(51) Int. Cl. G06Q 10/0635; G06F 16/242

(52) U.S. Cl. CPC G06Q 10/0635; G06F 16/243

(57) ABSTRACT

A system and method for due diligence optimization facilitates risk assessment in transactions by receiving subscriber health assessment data, extracting features via machine learning, and generating risk scores for matching buyers and sellers. The method employs a centralized platform with natural language processing and distributed ledger for secure data exchange. Enhancements include dynamic vector-guided depth-limited graph traversal for hierarchical question structures: generating query embeddings, retrieving node embeddings via HNSW indexing (M=16 links, ef_construction=200), computing cosine similarities, determining adaptive depth D using logarithmic formula based on relevance, pre-warming CPU cache, executing bounded traversal with lazy loading, and returning single-response results.

### CROSS-REFERENCE TO RELATED APPLICATION

This application is a continuation in part of U.S. patent application Ser. No. 17/461,121 filed Aug. 30, 2021, and through that application claims priority to U.S. Provisional Pat. App. No. 62/706,222 filed Aug. 28, 2020, the entireties of each of which are hereby incorporated by reference.

### FIELD OF THE INVENTION

The inventive disclosure relates in general to information gathering systems, and in particular, to methods of organizing prompts to elicit information and loading them from memory for an active session in a way that reduces memory usage and improves processing speed, including dynamic vector-guided depth-limited graph traversal with adaptive optimization.

### BACKGROUND OF THE INVENTION

Investigations conducted in order to determine the value and amount of risk associated with assets and liabilities of an entity are essential to properly ascertain the overall value of the entity. Prior to substantive conversations relating to partnerships, investments, acquisitions, mergers, and joint ventures taking place, the buyer and seller typically conduct a due diligence assessment in order to evaluate risks. Historically, due diligence assessments included a subjective approach using data collection and in-person interviews specific to the buyer and/or seller. A major drawback to this approach is that accurate risk calculation is based on market and the interviewer's experience with volatile factors such cross-industrial influences, economics, regulations, and other applicable factors. In addition, when attempting to assess various aspects of an entity such as back-office functions, cyber security, etc., information must be collected from not only the seller, but also multiple subject matter experts along with the buyer's own cybersecurity personnel so that the most valuable assessments are rendered. A common method of automating information gather for due diligence, and similar information intensive endeavors, is to construct a question tree. The questions tree starts with high level questions, and based on the answers provided, traverses the tree downward into more detailed questions.

These current approaches require a significant amount of time and manual resources to perform the assessments. In addition, there is a lack of centralization for conducting due diligence assessments, rendering an already convoluted process significantly more complicated. Previous systems have attempted to provide mechanisms to quantify risk factors in the due diligence process. For example, U.S. Pat. App. Pub No. 2021/0089980 to Akey et al., describes systems and methods for automating operational due diligence analysis to objectively quantify risk factors. However, the aforementioned systems and methods fail to provide a mechanism configured to facilitate due diligence assessments specific to buyers and sellers in a centralized manner. In addition, the aforementioned systems and methods fail to provide a mechanism that generates a due-diligence-based roadmap to ensure that both the buyers and sellers are progressing towards risk reduction at both an individual level and a transactional level.

A major issue with these question tree-based systems is that they require large amounts of resources to load and process. A typical hierarchical question tree can have on the order of ten thousand nodes. For full graph traversal, this requires on the order of 18 Gigabytes of memory for typical due diligence datasets. In the course of traversing the question tree, it is not uncommon to have multiple round trip queries, and presently these take several seconds in response time to process. Further, the static depth limits can miss critical information, or simply waste resources if the elicited information is not useful. These static questionnaires fail to adapt to the specific characteristics of each transaction and risk profile, often missing critical risk factors, especially in complex mergers and acquisition cases where, for example, “unknown unknowns” pose the greatest integration risks, domain expertise varies significantly across industries, critical information often lies in “rabbit holes” that are unexplored, and dependencies of often overlooked. Existing graph databases lack mechanisms to dynamically adjust traversal depth based on relevance. These kinds of limitations make real time adaptive due diligence impractical, and in need of technological solutions.

Yet another issue with current approaches to due diligence assessments is the lack of security and protection of seller and buyer specific data. For example, it is common during due diligence assessments for buyers, sellers, and other applicable parties to provide countless forms and documents that are classified and examined in order to accurately assess risks and benefits. However, there is a strategic advantage for parties to limit or redact information provided during certain periods of time of the due diligence process that is preferably done in a manner that does not disrupt the natural flow of communication between parties. For example, a selling party may have an outstanding financial portfolio; however, the party may have an unfavorable reputation within an industry for various reasons which may not be ascertainable by the buying party in real-time during negotiations. Often times, large volumes of documentation are placed into virtual data rooms in no particular arrangement for manual review by the diligence team with significant, costly time spent to deciding if the documents contain any valuable information outside of the conducted data-collection from live interviews. Rarely are data rooms properly protected to offer viewing of sensitive documents only to the right individuals with specific roles and responsibilities during the transaction processes. The documents in the virtual data room are also allowed to be downloaded by the individual reviewers, regardless of their roles in the process, creating a local copy of sensitive information that may not be properly protected. Although communication platforms exist, they are currently not configured to provide security mechanisms at the level that should become standard for due diligence assessment-based transactions.

What is needed is a system configured to facilitate due diligence assessments in a centralized manner while circumventing the aforementioned issues.

### SUMMARY OF THE DISCLOSURE

The invention provides systems and methods for optimizing due diligence along with one or more secure modules for hosting transactions based on the optimized due diligence that overcomes the hereinafore-mentioned disadvantages of the heretofore-known devices and methods of this general type.

The invention provides systems and methods for optimizing due diligence assessments in a centralized platform, addressing inefficiencies in traditional question tree traversals, data security, and risk quantification for transactions such as mergers and acquisitions. A server receives an initial health assessment landscape for a first subscriber, extracts health assessment data using dynamic vector-guided depth-limited graph traversal of hierarchical question structures, and employs machine learning to train a classification model that generates risk scores by comparing feature values from the initial and optimum landscapes. The traversal process generates query embeddings, retrieves node embeddings via Hierarchical Navigable Small World (HNSW) indexing, computes cosine similarities, determines an adaptive depth threshold using a logarithmic formula, pre-warms CPU cache, and executes bounded traversal with lazy loading to reduce computational resources (e.g., CPU cycles by at least 85%, memory by 70%). Additional modules include natural language processing for data extraction, a distributed ledger for secure communications and data storage in an evidence virtual data room, reputation analysis via domain inspection and crawling, and generation of comprehensive roadmaps for risk reduction. The system matches subscribers based on risk thresholds, facilitating secure transactions while improving processing speed and data privacy.

In accordance with some embodiments of the inventive disclosure, there is provided a method for due diligence optimization that include receiving, via a server, an initial health assessment landscape pertaining to a first subscriber on a centralized platform operated by the server. The method further include extracting, via the server, a plurality of health assessment data from the initial health assessment landscape. The extracting includes receiving a natural language query input pertaining to the initial health assessment landscape, generating a query embedding vector using a trained neural language model, retrieving from a graph database node embeddings representing vertices in a hierarchical question structure, computing similarity scores between the query embedding and node embeddings using cosine similarity calculation, determining a dynamic traversal depth threshold D, pre-warming CPU cache lines with metadata for top-K similar nodes, where K is determined based on D and an average branching factor, executing a bounded graph traversal limited to depth≤D, with lazy node loading using cursor-based streaming, to extract the plurality of health assessment data, and returning results in a single network response to extract further health assessment data via further natural language query input that is responsive to the results. The method also includes storing training data that comprises a plurality of training instances, wherein each training instance of the plurality of training instances corresponds to at least a subset of the plurality of health assessment data. The method further includes utilizing one or more machine learning techniques to train a classification model based on the training data, identifying a first plurality of feature values associated with an optimum health assessment landscape, identifying a second plurality of feature values associated with the initial health assessment landscape, inserting the first and second pluralities of feature values into the classification model that generates an output that is a score indicating a level of risk associated with the first subscriber, and presenting the first subscriber to a second subscriber based upon the score exceeding a predetermined threshold.

In accordance with a further feature, said vector comprises at least 384 dimensions.

In accordance with a further feature, the dynamic depth threshold D is calculated using the formula:

$$D = min ( D max , ⌈ {log}_{2} ( \sum ( similarity\_scores > θ ) ⋆ \vert V \vert / baseline\_nodes ) ⌉ )$$

where:
Dmax is a system-defined maximum depth,
θ is a similarity threshold,
   |V|is total graph vertices,
baseline_nodes is an empirically determined constant.

In accordance with a further feature, the node embeddings are indexed using Hierarchical Navigable Small World (HNSW) data structures configured with M=16 bidirectional links per layer and ef_construction=200 for index building.

In accordance with a further feature, executing the bounded graph traversal further comprises pruning nodes with similarity scores below the similarity threshold θ during traversal to reduce computational resource usage.

In accordance with a further feature, the lazy node loading uses batch sizes of 256 nodes and employs cursor-based streaming to avoid loading the entire hierarchical question structure into memory.

In accordance with a further feature, pre-warming the CPU cache lines uses single instruction multiple data (SIMD) prefetch instructions to load metadata for the top-K similar nodes, reducing cache misses by at least 35%.

In accordance with a further feature, the method further includes receiving a plurality of subject matter expert opinions; identifying a fourth plurality of feature values associated with the plurality of subject matter expert opinions; and inserting the fourth plurality of feature values into the classification model to refine the score indicating the level of risk.

In accordance with a further feature, the centralized platform includes a security module with a distributed ledger configured to monitor and record access to sensitive data extracted from the initial health assessment landscape, using proof-of-collaboration consensus mechanisms.

In accordance with a further feature, the method further includes storing the extracted plurality of health assessment data in an evidence virtual data room with timestamping and two-layer storage functionality to ensure data privacy and granular access control.

In accordance with some embodiments of the inventive disclosure, there is provided a system for due diligence optimization with adaptive resource management that includes a server communicatively coupled to a database storing a hierarchical question structure represented as a graph. The system also includes a due diligence module executed by the server and configured to receive an initial health assessment landscape pertaining to a first subscriber on a centralized platform operated by the server, and extract a plurality of health assessment data from the initial health assessment landscape. The plurality of health assessment data by receiving a natural language query input pertaining to the initial health assessment landscape, generating a query embedding vector using a trained neural language model, retrieving from the graph database node embeddings representing vertices in the hierarchical question structure, the node embeddings indexed using Hierarchical Navigable Small World (HNSW) data structures, computing similarity scores between the query embedding and node embeddings using cosine similarity calculation; determining a dynamic traversal depth threshold D, pre-warming CPU cache lines with metadata for top-K similar nodes, where K is determined based on D and an average branching factor, executing a bounded graph traversal limited to depth≤D, with lazy node loading using cursor-based streaming, to extract the plurality of health assessment data, and returning results in a single network response to extract further health assessment data via further natural language query input that is responsive to the results. The system further includes a machine learning module communicatively coupled to the due diligence module and configured to store training data comprising a plurality of training instances, wherein each training instance corresponds to at least a subset of the plurality of health assessment data, utilize one or more machine learning techniques to train a classification model based on the training data, identify a first plurality of feature values associated with an optimum health assessment landscape, identify a second plurality of feature values associated with the initial health assessment landscape, insert the first and second pluralities of feature values into the classification model to generate an output that is a score indicating a level of risk associated with the first subscriber, and present the first subscriber to a second subscriber based upon the score exceeding a predetermined threshold.

In accordance with a further feature, the machine learning module further includes: a training data module for dynamically updating the training data; an update module for periodically replacing the classification model with a new model based on updated training data; and a prediction module for generating real-time risk scores.

In accordance with a further feature, the system further includes a reputation module configured to: perform domain inspection, background checks, web crawling, and network evaluation on the first subscriber; and generate reputation data integrated into the plurality of health assessment data.

In accordance with a further feature, the system further includes a communication module integrated with the security module, the communication module configured to facilitate secure exchanges between the first subscriber and the second subscriber using the distributed ledger to prevent unauthorized data downloads.

In accordance with a further feature, the due diligence module is further configured to integrate a neural scoping function that evaluates responses during graph traversal to dynamically select a new starting node in the hierarchical question structure, reducing memory usage by at least 70%.

In accordance with a further feature, the bounded graph traversal reduces CPU cycles by at least 85% compared to full-depth traversal of the hierarchical question structure.

In accordance with a further feature, the system is further configured to receive a plurality of tags associated with subscriber-specific data; traversing a plurality of subscriber-specific data using natural language processing (NLP); generating an NLP model including a plurality of features associated with the plurality of tags; extracting a subset of the plurality of subscriber-specific data based on outputs of the NLP model; and integrating the subset into the training data for the classification model.

In accordance with a further feature, the system is further configured to identify a third plurality of feature values associated with at least one of the first subscriber and the second subscriber; and inserting the third plurality of feature values into the classification model to generate an output that is a comprehensive roadmap for risk reduction.

In accordance with a further feature, the trained neural language model is a sentence-transformers/all-MiniLM-L6-v2 model, and the query embedding vector is fused with prior response vectors via averaging or concatenation to refine relevance.

In accordance with some embodiments of the inventive disclosure, there is provided a method for due diligence analysis in a centralized platform that includes receiving, via a server, a plurality of objective data and a plurality of subscriber-specific data associated with a first subscriber. The method further includes receiving a plurality of tags for identifying relevant data, traversing the plurality of subscriber-specific data while applying natural language processing (NLP), generating an NLP model including a plurality of features associated with the plurality of tags, extracting a subset of the plurality of subscriber-specific data based on one or more outputs of the NLP model, storing training data comprising a plurality of training instances, wherein each training instance corresponds to at least the subset of the plurality of subscriber-specific data, utilizing one or more machine learning techniques to train a classification model based on the training data, identifying a first plurality of feature values associated with an optimum health assessment landscape, identifying a second plurality of feature values associated with an initial health assessment landscape of the first subscriber, identifying a third plurality of feature values associated with at least one of the first subscriber and a second subscriber, inserting the first, second, and third pluralities of feature values into the classification model to generate an output that is a comprehensive roadmap for transactional risk reduction, and presenting the comprehensive roadmap to the first subscriber and the second subscriber via the centralized platform.

Although the invention is illustrated and described herein as embodied in a system and methods for autonomy of uninterrupted power supply systems, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram depicting an exemplary system for due diligence optimization, according to an example embodiment.

FIG. 2 is a block diagram depicting an exemplary due diligence module of the system of FIG. 1, according to an example embodiment.

FIG. 3 is a block diagram depicting an exemplary set of assessment areas inserted into a machine learning module of the due diligence module of FIG. 2, according to an example embodiment.

FIG. 4 is a block diagram depicting an exemplary data flow of the system of FIG. 1, according to an example embodiment.

FIG. 5 is a block diagram depicting an exemplary method for optimizing due diligence, according to an example embodiment.

FIG. 6 is a block diagram depicting an exemplary method for a due diligence analysis, according to an example embodiment.

FIG. 7 is an illustration of an exemplary user interface associated with the system of FIG. 1, according to an example embodiment.

FIG. 8 illustrates a computer system according to exemplary embodiments of the present technology.

FIG. 9 is a block diagram of a due diligence system which incorporates an exemplary dynamic vector-guided depth-limited graph traversal module integrated into the due diligence module of FIG. 2, for reducing computational resource usage in carrying a due diligence inquiry, according to an example embodiment.

FIG. 10 shows an example of a dynamic depth calculation in a question tree traversal in which a neural scoping function determines a new starting location in the question tree based on the relevancy of a response in order to reduce computational loading, in accordance with some embodiments.

FIG. 11 shows method of carrying out a dynamic depth operation in the traversal of a large node numbered question tree of a due diligence system, in accordance with some embodiments.

FIG. 12 shows an example of a dynamic bounding used in traversing a large node number graph, in accordance with some embodiments.

FIGS. 13A and 13B compare the dynamic depth operation with a prior art system, indicating the difference in time and resource usage.

FIG. 14 shows a vector search operation for dynamic depth when traversing a large number node graph, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides novel and efficient systems for optimizing due diligence and various components of due diligence assessments that not only centralize the rendering and facilitation of due diligence assessments, but also provide security mechanisms for sensitive and/or confidential information acquired for due diligence assessments. Embodiments of the invention provide a system and a method configured to optimize due diligence including a server designed to generate a centralized platform and configured to receive an initial health assessment landscape pertaining to a first subscriber on a centralized platform operated by the server; extract a plurality of health assessment data from the initial health assessment landscape; store training data that comprises a plurality of training instance, wherein each training instance of the plurality of training instances corresponds to at least a subset of the plurality of health assessment data; utilize one or more machine learning techniques to train a classification model based on the training data; identify a first plurality of feature values associated with an optimum health assessment landscape; identify a second plurality of feature values associated with the initial health assessment landscape; insert the first and second pluralities of feature values into the classification model that generates an output that is a score indicating a level of risk associated with the first subscriber; and present the first subscriber to a second subscriber based upon the score exceeding a predetermined threshold. In acquiring data for the initial health landscape, questionaries and surveys can be used to gather due diligence information (i.e. information relevant to the due diligence inquiry). Because this form of information gathering, even when automated, is time a computationally prohibitive, embodiments of the invention use a ‘level of detail’ type operation to traverse question trees, greatly reducing the time it takes as well as reducing the computational resources needed to conduct these processes. Embodiments of the invention further provide a due diligence module and a machine learning server configured to utilize machine learning algorithms on training data sourced from subscribers operating on the centralized platform in addition to subject matter experts in order to render analyses, predictions, and scores pertaining to one or more components associated with due diligence assessments and transactions based on due diligence assessments. Embodiments of the invention further provide a communications module configured to increase the security and privacy of data acquired during negotiations and transactions involving due diligence assessments. The communications module is configured to communicate with a security module including a distributed ledger to monitor components of due diligence assessments and transactions involving due diligence assessments, such as exchanges between buyer and seller or exchanges between buyer/seller and applicable third parties. Embodiments of the invention further provide mechanisms for proper storage and security/protection of sensitive data generated for and/or derived from due diligence assessments. The systems and methods described herein provide improvements to the collection, storage, processing, filtering, and management of data necessary for due diligence assessments. The systems and methods described herein further provide improvements to the facilitation of due diligence assessments in addition to communication sessions of transactions involving due diligence assessments, and storage and protection of data associated with due diligence assessments in a manner that reduces processing costs of computations.

With regard to the problem of traversing question trees for gather information, the concept of Level of Detail (LOD) used in computer graphics has inspired a solution: dynamically adjust the depth and breadth of due diligence inquiries based on real-time relevance signals. The present invention addresses these technical challenges through a vector-guided dynamic depth optimization system. While motivated by the need for adaptive due diligence, the innovation provides broadly applicable performance improvements for any hierarchical graph query system. Initial prototypes attempting to implement LOD-based diligence revealed that similarity-based depth calculation could reduce resource consumption by 85% while maintaining query completeness. Prior art static questionnaires cannot adapt to transaction-specific risk profiles. Existing graph databases lack mechanisms to dynamically adjust traversal depth based on relevance. The inventor discovered that vector similarity could predict optimal exploration depth. This invention enables adaptive systems by solving a fundamental performance bottleneck in due diligence inquiries and data gathering. The Hierarchical Navigable Small World (HNSW) algorithm is a graph-based method for efficient approximate nearest neighbor (ANN) search in high-dimensional vector spaces, commonly used in vector databases for tasks like similarity search in embeddings. HNSW builds on navigable small world (NSW) graphs and probabilistic skip lists to achieve high recall with logarithmic search complexity to greatly improve the efficiency in time and computing resource usage in collecting due diligence information using automated surveys and questionnaires.

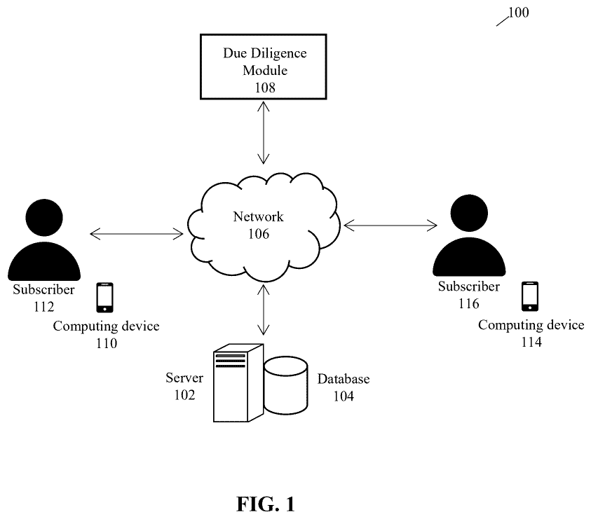

Referring now to FIG. 1, a system for due diligence optimization 100 is depicted, according to an exemplary embodiment. In one embodiment, system 100 includes a server 102 communicatively coupled to a database 104, a communicative network 106, a due diligence module 108, a computing device 110, a first subscriber 112 operating on computing device 110, a computing device 114, and a second subscriber 116 operating on computing device 114. In some embodiments, server 102 is configured to generated a centralized platform hosted over network 106 accessible by subscribers 112 and 116 via computing devices 110 and 114. In some embodiments, each of the aforementioned components of system 100 are designed and configured to be communicatively coupled via network 106. In some embodiments, network 106 may be implemented as a Local Area Network (LAN), Wide Area Network (WAN), mobile communication network (GSM, GPRS, CDMA, MOBITEX, EDGE), Ethernet or the Internet, peer-to-peer network, one or more terrestrial, satellite or wireless links, or any medium or mechanism that provides for the exchange of data between the aforementioned components of system 100. System 100 illustrates only one of many possible arrangements of components configured to perform the functionality described herein. Other arrangements may include fewer or different components, and the division of work between the components may vary depending on the arrangement. As described herein, a computing device may be a mobile phone, tablet, smart phone, desktop, laptop, wearable technology, or any other applicable device or system including at least a processor.

In some embodiments, database 104 is configured to house a plurality of subscriber records designed to be associated with subscribers of the centralized platform. For example, each subscriber record of the plurality of subscriber records may include a subscriber profile generated by server 102 based on a plurality of objective data received by server 102 along with other applicable data associated with subscribers on the centralized platform. It is to be understood that the plurality of objective data may be utilized by server 102 to generate an initial health assessment landscape pertaining to the applicable subscriber on the centralized platform. In some embodiments, the initial health assessment landscape is received by server 102 from at least one of subscribers 112 or 116, or any applicable party configured to provide health assessment landscapes. It is to be understood that initial health assessment landscapes are configured to include data pertaining to short term event studies (STES), long term event studies (LTES), accounting based measures, event studies/stock-market based measures (short-run and long-run), accounting (return on assets, return on equity, operating cash flows), subjective assessments of managers, subject matter expert assessments, divestment measures, and any other applicable performance measures associated with mergers and acquisitions. In some embodiments, server 102 is configured to generated an initial health assessment landscape from the plurality of objective data based on one or more of 1) subjective/objective assessments; 2) short-term/long-term perspective; 3) expected/realized returns; 4) public/private information; 5) separate/combined returns to acquiring firm; 6) task level/acquisition project level/firm level, or any other applicable merger and acquisition dimensions. In some embodiments, server 102 is configured to process one or more questionnaires in which server 102 is configured to supply answers to the questionnaires extractable from the plurality of objective data, if a component of a questionnaire cannot be completed by server 102 then server 102 transmits a prompt to one of subscribers 112 or 116, or the applicable third party in order for the questionnaire to be completed. It is to be understood that due diligence module 108 is designed and configured to communicate with server 102 in order to provide due diligence assessments in which in some embodiments, due diligence module 108 may integrate one or more of the due diligence assessments into the initial health assessment landscape. In some embodiments, the due diligence assessments may take into account one or more risk factors pertaining to procedures, policies, structure, or abilities of the buyer/seller associated with the initial health assessment landscape while server 102 is generating the initial health assessment landscape. In some embodiments, server 102 extracts a plurality of health assessment data from the initial health assessment landscape. It is to be understood that the extraction of the plurality of health assessment data may be based on factors specific to subscribers 112 and/or 116 and/or the applicable transaction. For example, first subscriber 112 may indicate to server 102 via the centralized platform that overestimation is a concern and the desire is to be conservative in which server 102 filters the initial health assessment landscape (generated based on the plurality of objective data) from one or more valuation spreadsheets and extracts the applicable data from valuation spreadsheets ultimately for the purpose of determining synergies.

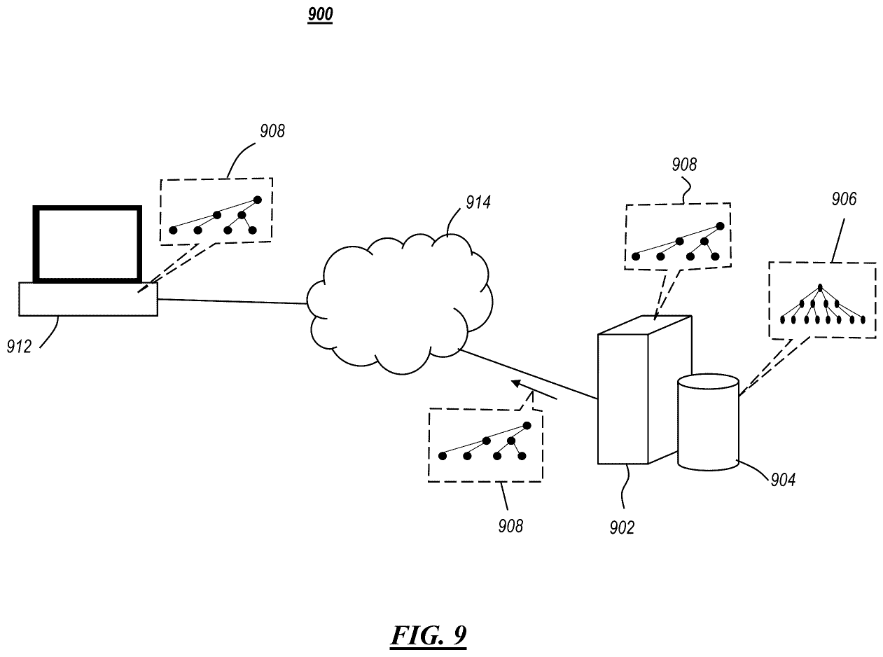

In providing questionnaires and surveys to acquire initial health assessment landscape, a question tree is used. In large due diligence operation these question trees have can a large number of nodes, on the order of ten thousand to one hundred thousand questions, where each node of the tree includes a question and associated decision logic to determine the next node to be processed. In prior art question tree systems, and decision graph processing in general, question trees are traversed linearly, which can require a prohibitively long time to complete, and use large amounts of computing resources. In addition, the prior art methods can collect redundant data while missing relevant data. The systems and processes of FIGS. 9-14 show how the inventive due diligence system instead uses a dynamic level of detail operation to more efficiently traverse a large node number graph, and acquire the necessary relevant information to complete the due diligence.

As described herein, the plurality of objective data may include but is not limited to third-party vendor assessments, industry best practices, public frameworks, subject matter expert personal experiences, applicable white papers, applicable research papers, scientific journals, patents, published statistics and trends, blogs, articles, and the system's own data analytics and machine learning models.

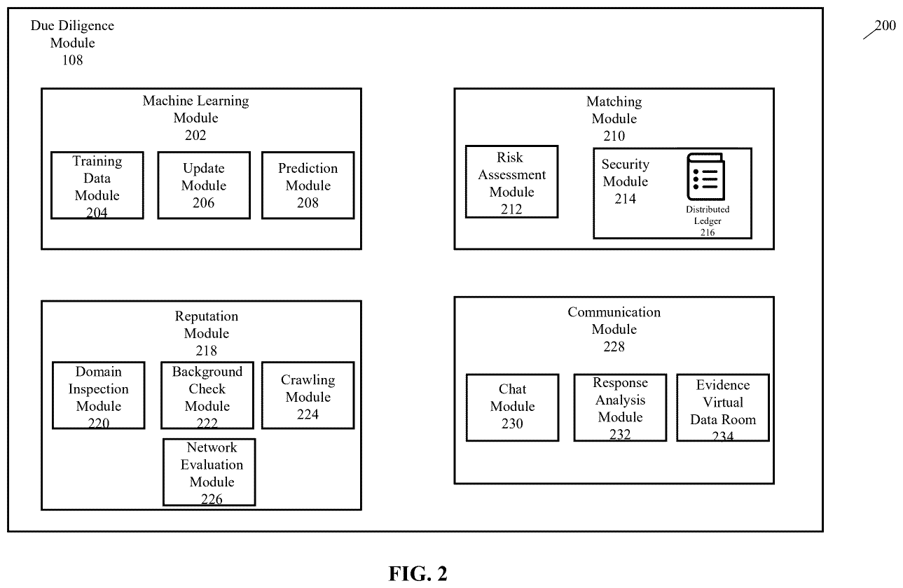

Referring now to FIG. 2, a configuration 200 of due diligence module 108 is depicted, according to an exemplary embodiment. In some embodiments, due diligence module 108 includes a machine learning module 202 including a training data module 204, an update module 206, and a prediction module 208. In some embodiments, due diligence module 108 further includes a matching module 210 including a risk assessment module 212 and a security module 214 including a distributed ledger 216. In some embodiments, due diligence module 108 further includes a reputation module 218 including a domain inspection module 220, a background check module 222, a crawling module 224, and a network evaluation module 226. In some embodiments, due diligence module 108 further includes a chat module 230, a response analysis module 232, and an evidence virtual data room 234. It is to be understood that other arrangements may include fewer or different components, and the division of work between the components may vary depending on the arrangement.

In some embodiments, machine learning module 202 may include a machine learning server communicatively coupled to server 102 configured to generate a classification model based on training data (of training data module 204) utilizing one or more machine learning techniques, in which feature values and/or training data (instances of the training data) are configured to be inserted into the classification model. In some embodiments, machine learning module 202 may be configured to generate a natural language processing (NLP) model for the purpose of determining types of data to be extracted from a plurality of subscriber specific data associated with at least one of subscribers 112-16. It is to be understood that machine learning as provided is the study and construction of algorithms that can learn from, and make predictions on, data. Such algorithms operate by building a model from inputs in order to make data-driven predictions or decisions generated by prediction module 208. The machine-learned model is trained based on multiple attributes (or factors) described herein. In machine learning parlance, such attributes are referred to as “features”. In some embodiment, various feature weights or coefficients are established in order to accurately generate predictions, analyses, and/or scores for system 100. Training data module 204 allows the training data to be dynamically acquired over long periods of time. For example, a new machine-learned model is generated regularly, such as every hour, day, month, week, or other time period. Update module 206 allows the new machine-learned model to replace a previous machine-learned model in order to ensure that outputs of prediction module 208 are up to date in real-time. Newly acquired or changed training data may be used to update the model via assistance from update module 206. Machine learning module 202 with assistance from training data module 204 is configured to store training data that includes a plurality of training instances, each of which includes a plurality of feature values derived from and/or associated with the initial health assessment landscape, an optimum health assessment landscape, server 102 (the plurality of objective data), or an applicable third party.

In some embodiments, evidence virtual data room 234 serves as the location of storage of filtered and unfiltered data configured to be allocated among the plurality of slots. In some embodiments, security and sensitivity of data within evidence virtual data room 234 is maintained via security module 214 in which access and modification to data is monitored on distributed ledger 216. It is to be understood that evidence virtual data room 234 utilizing mechanisms such as the security module 214 and encryption mechanisms may allow data storage to be infinitely granularized reducing the processing cost for computation of data of system 100 while ensuring privacy of sensitive data on distributed ledger 216. In some embodiments, distributed ledger 216 utilizes local reference-based consortium schemes and consensus mechanisms, such as Proof-of-Collaboration, for computational resources reduction within the framework of system 100. In some embodiments, evidence virtual data room 234 is configured to provide timestamping and two-layer storage functionality in order to protect sensitive of data allocated among the plurality of slots.

As described herein, subscriber specific data includes but is not limited to technology architecture diagrams, technical debt inventory, development operations, software development lifecycle metrics, quality assurance test and automation coverage, organization census, identification of key personnel, talent mix, talent gaps, tenure, executive and senior management backgrounds, call center metrics, onboarding metrics, infrastructure model, network diagrams, system and network component sizing and utilizations, utilities, financial statements, software license agreements, budgets, product roadmaps, project plans, external public data including opinions, complaints, breached data, HR processes, compliance metrics, cybersecurity processes, audit reports, penetration test results, vulnerability scan results, employee training methods, certifications, back office systems, vendor contracts, capex budget breakdown, opex budget breakdown, system uptime, asset refresh cycle, outage reports, policies, failed releases, failed projects, employee performance, personnel under performance improvement plans, organization key performance metrics, support tickets, escrow agreements, facilities summary, scalability constraints, disaster recovery plans and test results, patch management processes, historical exceptions, information security plan, security component configurations, data encryption methods, network performance metrics, external application programming integrations, open source audits, customer lifetime value and acquisition costs, lead to customer rate, utilization spike patterns and reasons, largest customer transaction volumes, personnel attrition rates, customer attrition rates, similar competitor metrics, market penetration and sizing, software tenancy models, email history, internal chat system history, dark web scan for related information, customer interviews, outstanding liens, AI/ML models, pending legal activities, among others.

In some embodiments, due diligence module 108 is configured to generate a due diligence analysis pertaining to at least one of first subscriber 112 or second subscriber 116 in which the due diligence analysis includes due diligence module 108 receiving a plurality of tags from server 102 and/or the machine learning server. It is to be understood that the plurality of tags are determined based upon one or more factors including but not limited to components of the initial health assessment landscape, the optimum health assessment landscape, filtration of the plurality of objective data, preferences of one of subscribers 112-116, the machine learning server, the nature of the transaction involving subscribers 112-116, or any other applicable source configured to determine tags for the purpose of data extraction. The plurality of subscriber specific data is traversed by due diligence module 108 allowing machine learning module 202 to apply natural language processing in order for machine learning module 202 to generate the NLP model. In some embodiments, the NLP model is configured to generate outputs in which the outputs assist server 102 and/or due diligence module 108 in extracting a subset of the plurality of subscriber specific data. In a preferred embodiment, the subset of the plurality of subscriber specific data is transmitted to training data module 204. It is to be understood that the purpose of the NLP model is to detect applicable data within the plurality of objective data and the plurality of subscriber specific data to be included in the feature values of the training data managed by training data module 204. In some embodiments, machine learning module 202 utilizes one or more machine learning techniques to train the classification model based on the training data including the subset of the plurality of subscriber specific data.

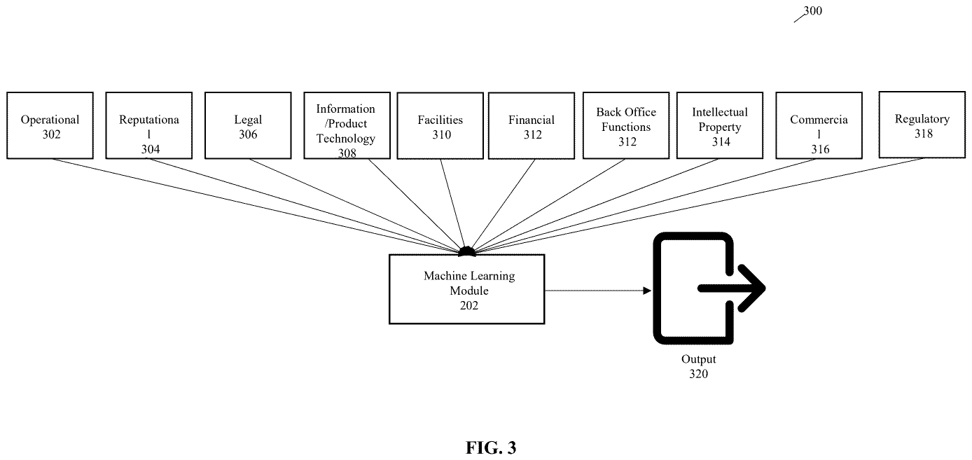

It is to be understood that the optimum health assessment landscape is configured to be an objective representation of a hypothetical or literal party operating at the optimum level across the spectrum of areas applicable to a due diligence assessment. In some embodiments, the optimum health assessment landscape may be a target and/or template necessary in order to calculate one or more metrics associated with the overall health, safety, or risk of one of subscribers 112 and 116. For example, by the machine learning server utilizing one or more machine learning techniques to train the classification model, server 102 and/or the machine learning server is able to identify a first plurality of feature values associated with the optimum health assessment landscape and a second plurality of feature values associated with the initial health assessment landscape. The first and second pluralities of feature values are inserted into the classification model resulting in generation of one or more outputs associated with one of subscribers 112 and 116. This is discussed in greater detail in reference to FIG. 3.

In some embodiments, prediction module 208 is configured to generate one or more analyses or scores pertaining to one of subscribers 112 and 116 based on data processed by server 102, machine learning server 202 and due diligence module 108. In some embodiments, server 102, alone or in combination with prediction module 208, generates a comprehensive road map configured to include one or more of the predictions, analyses, and/or scores pertaining to one of subscribers 112 or 116. In some embodiments, the comprehensive road map is an interactive tool integrating the plurality of objective data and/or the plurality of subscriber specific data configured to assist subscribers with progression towards the optimum health assessment landscape. In some embodiments, prediction module 208 computes a digital score associated with one of subscribers 112 and 116 in real-time. In some embodiments, the digital score represents an aggregation of risks/threat associated with one of subscribers 112 and 116, or indicator of the likelihood of economic, social, reputational, or security risk/threat to a potential buyer. In some embodiments, the digital score may be transmitted to server 102 via an application program interface (API) that may interact with various components of the centralized platform. In some embodiments, the digital score may be transmitted to server 102 to not only be stored in the applicable subscriber record housed in database 104, but also the digital score is configured to be utilized by update module 206 in order for real-time optimization of generating the comprehensive road map.

In some embodiments, server 102 may establish a predetermined threshold in which the digital score must exceed in order for the subscriber associated with the digital score to be presented to other subscribers of the centralized platform. The predetermined threshold may be established based off of computations performed by server 102 or via preferences established by one of subscribers 112 and 116 regarding metrics or desires for entities that they wish to buy from or sell to. The purpose of matching module 210 is to allow due diligence module 108 to effectively match prospective buyers with prospective sellers on the centralized platform. In the instance where first subscriber 112 is a seller and second subscriber 116 is an acquirer, machine learning module 202 generates the digital score associated with first subscriber 112 in which matching module 210 utilizes risk assessment module 212 to ascertain the predetermined threshold associated with second subscriber 116 if applicable and instructs server 102 to access each subscriber record associated with a subscriber on the centralized platform including digital scores that exceed the predetermined threshold. As a result, server 102 provides a subscriber profile associated with each subscriber including digital scores that exceed the predetermined threshold to second subscriber 116 via a user interface of the centralized platform.

In some embodiments, matching module 210 utilizes security module 214 to privatize, redact, and/or sanitize one or more applicable components of the subscriber profile. The purpose behind the functionality of security module 214 is due to the fact that confidentiality agreements and other applicable mechanisms are inherent to the merging and acquiring of entities. For example, the commercial advantages that an entity may source from sensitive/confidential information lies in the capacity to keep said information secret and prevent other parties from gaining access to it. Thus, security module 214 is designed and configured to utilize machine learning module 202 in combination with server 102 to flag data within the plurality of objective data and/or the plurality of subscriber specific data to detect that should be redacted and/or sanitized prior to inclusion in the subscriber profile being presented to the applicable subscriber. In some embodiments, security module 214 utilizes distributed ledger 216 maintained by a trusted authority in order to monitor assets of at least one of first subscriber, second subscriber 116, one or more transactions, or any other applicable components of system 100. It is to be understood that distributed ledger 216 may include a plurality of chained blocks configured to be distributed across peer systems in which each block may represent a transaction or component of a transaction including but not limited to identifying information, digital signatures, private/public keys, etc.

In some embodiments, reputation module 218 is designed and configured to generate scores, rankings, and/or classifications associated with first subscriber 112 or second subscriber 116. It is to be understood that the purpose of reputation module 218 is to provide prospective buyers and sellers with real-time data pertaining to the professional and social standing or status of first subscriber 112 or second subscriber 116. In some embodiments, reputation module 218 may account for the overall sustainability associated with various aspects of each party of the one or more transactions. For example, by reputation module 218 acquiring data associated with first subscriber 112/second subscriber 116 and their applicable personnel, reputation module 218 is configured to generate a sustainability score that accounts for the power consumption, resource consumption, worker locale, carbon utilization/calculations, office asset recycling, or any other sustainability factor. The sustainability score is configured to not only be integrated into machine learning module 202, but also in the calculation of the risk score. In some embodiments, reputation module 218, alone or in combination with server 102, is configured to monitor social media interactions including but not limited to posts, tags, profile information, content interactions, or any other applicable social media actions known to those of ordinary skill in the art. Reputation module 218 may include one or more bots (“web crawlers”), managed by crawling module 224, configured to traverse a plurality of nodes included within one or more webpages in which upon traversing the plurality of nodes, the web crawlers are configured to perform text/media analysis and extraction. Reputation module 218 utilizes the data acquired from the traversing of the web crawlers to assess one or more reputations associated with first subscriber 112 or second subscriber 116. For example, the web crawlers may access the Twitter page of first subscriber 112 including not only tweets posted by first subscriber 112 or an agent of first subscriber 112, but also tweets of others tagging/mentioning first subscriber 112. Based on the analysis of the plurality of nodes of the Twitter page, reputation module 218 is able to generate a score, ranking, or classification associated with the social and professional reputation of first subscriber 112. In some embodiments, domain inspection module 220 is configured to utilize the web crawlers to perform private and public domain crawls pertaining to both first subscriber 112 and agents of first subscriber 112. The purpose of domain inspection module 220 is to allow due diligence module 108 to review the personal and private networks of first subscriber 112 and its agents to access potential referrals within the aforementioned networks. In some embodiments, data acquired by the web crawlers allows domain inspection module 220 to ascertain the social and professional reputation of first subscriber 112 and its agents by the web crawlers Uniform Resource Locators (URLs) from social media content based on keywords or the plurality of tags generated by machine learning module 202. In some embodiments, domain inspection module 220 classifies reputational related content within the one or more webpages in order for reputation module 218 to generate one or more reputational scores in which the reputational scores are configured to be integrated into at least one of analyses/predictions rendered by machine learning module 202 or the comprehensive road map. In some embodiments, crawling module 224 provides one or more user interfaces allowing the web crawlers to be configured in order to specify the type of reputational data that reputation module 218 should be processing.

In some embodiments, reputation module 218 utilizes background check module 222 in order to render one or more background checks associated with agents and/or employees of first subscriber 112 or second subscriber 116 in order to assist network evaluation module 226 with ascertaining one or more measurements of the value of the network associated with first subscriber 112 or second subscriber 116. The purpose of background check module 222 is to ensure that there are no limitations or inhibitors for transactions occurring on the centralized platform. It is to be understood that background check module 222 conducts automated background checks in accordance with the applicable governing rules and regulations. In some embodiments, background check module 222 conducts the background check based on due diligence module 108 detecting one or more individuals associated with first subscriber 112 or second subscriber 116 involved in one or more transactions on the centralized platform. It is to be understood that network evaluation module 226 utilizes data collected by the aforementioned modules of reputation module 218 in order to generate a scoring, grading, ranking, or classification (referred to hereinafter as “network evaluation score”) representing the current and/or prospective value of the social and professional network of first subscriber 112 or second subscriber 116. In some embodiments, the network evaluation score is configured to be stored on distributed ledger 216 within a block of the plurality of chained blocks in a confidential manner allowing the network evaluation score to be released to the applicable party upon one or more transactions reaching a identifiable stage in which the identifiable stage may be at least one of information exchange between first subscriber 112 and second subscriber 116, valuation and synergies, offer and negotiation, due diligence, or any other applicable stage of mergers and acquisitions known to those of ordinary skill in the art.

It is to be understood that communication module 228 is configured to be the mechanism of system 100 that provides one or more communicative sessions, hosted by chat module 230, between first subscriber 112 and second subscriber 116 in which communicative session includes video calls, audio calls, chat portals, or any other applicable communicative session known to those of ordinary skill in the art. The purpose of communication module 228 is to provide a means of facilitating transactions between first subscriber 112 and second subscriber 116 derived from matching module 210 matching second subscriber 116 with first subscriber 112 based upon the risk score of first subscriber 112 exceeding the predetermined threshold or in some instances the risk score not exceeding the predetermined threshold. In some embodiments, each communicative session is configured to be included in a timeline generated by communication module 228 in which the timeline includes a plurality of slots. The plurality of slots are configured to be filled with one or more of the plurality of objective data, the plurality of subscriber specific data, the one or more outputs, the plurality of subscriber specific data, or a combination thereof. In some embodiments, server 102 is configured to filter the aforementioned data based upon its content in order to allocate the data to the applicable slot, and in some instances the filter is applied based on data ascertained from the one or more outputs. One of the purpose of the slots is to designate one or more identifiable stages of one or more transactions and in which a plurality of evidence received by server 102 is allocated across the timeline at each of the plurality of slots. In some embodiments, the plurality of slots may be designated for specific types of data in which the type of data for the applicable slot is based upon the one or more outputs of machine learning module 202. In some embodiments, machine learning module 202 may apply an artificial intelligence and/or machine learned model to each slot of the plurality of slots. Applying specific models to the plurality of slots not only allows update module 206 to be utilized to account for updated, modified, or supplemental data fed into due diligence module 108, but also proper and/or more accurate classification of each slot for server 102 to filter applicable data to.

Communication module 228 automatically assesses each slot individually ensuring that modifications and updates of the distributed evidence, tracked and documented on distributed ledger 216, are accurate. In some embodiments, communication module 228 includes a communications module machine learning server configured to generates outputs indicating an assessment score of each slot. The communications module machine learning server is further configured to identify correlations and influences allowing the communications module machine learning server to predict an assessment of a slot of the plurality of slots that has not received evidence. For example, the plurality of evidence may be allocated among the plurality of slots; however, the slot representative of the deal closing phase may not be filled due to lack of applicable data within the plurality of evidence in which the communications module machine learning server to predict an assessment for that particular slot. In some embodiments, the plurality of evidence may be derived from one or more inputs from first subscriber 112, second subscriber 116, or an applicable subject matter expert. However, in the instance of an incomplete input, communications module machine learning server, based on detection of an empty slot by response analysis module 232, may generate an output representing a responsiveness score indicating the capability of maturity of the party providing the inputs. In some embodiments, a slot or one or more components of a slot may be filled based on the input or lack thereof of first subscriber 112, second subscriber 116, or the applicable subject matter expert.

Referring now to FIG. 3, a set of assessment areas 300 configured to be inserted into machine learning module 202 is depicted, according to an exemplary embodiment. In some embodiments, set of assessment areas 300 includes an operational category 302, a reputational category 304, a legal category 306, an information/product technology category 308, a facilities category 310, a financial category 312, a back office functions category 314, an intellectual property category 314, a commercial category 316, and a regulatory category 318. It is to be understood that other applicable categories known to those of ordinary skill in the art are within the spirit and scope of the disclosure. In some embodiments, assessment areas 300 are modules configured to solicit real-time responses to category specific questions generated by the modules designed to be answered by at least one of first subscriber 112, second subscriber 116, or the applicable subject matter expert. As provided above, machine learning module 202 is configured to generate an output 320 in which output 320 may be a prediction, analysis, score, or the comprehensive road map. In some embodiments, the modules may automatically generate questions for prompting on the centralized platform based on gaps of data detected by server 102. It is to be understood that the plurality of objective data and the plurality of subscriber specific data may be sourced, supplemented, and/or modified by data provided by assessment areas 300. Output 320 is transmitted to server 102 for storage the applicable subscriber record. In some embodiments, output 320 may be processed and securitized by matching module 210 prior to presentation on the centralized platform.

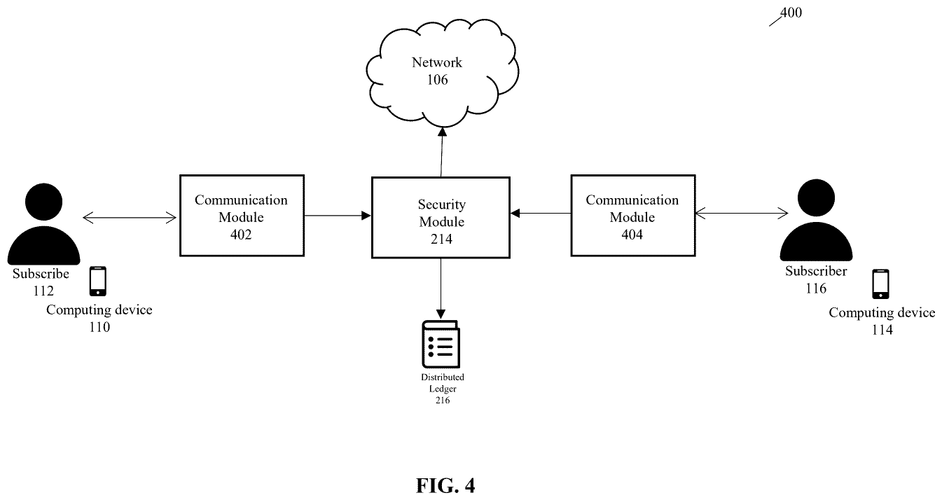

Referring now to FIG. 4, a data flow 400 of system 100 is depicted, according to an exemplary embodiment. It is to be understood that data flow 400 is an illustration of the data processing of one or more components of due diligence module; in particular, a first communication module 402 and a second communication module 404 interact with security module 214 in order to ensure that the plurality of objective data, the plurality of subscriber specific data, and any other applicable data within system 100 securely managed over network 106. Confidential and/or sensitive data specific to first subscriber 112 or second subscriber 116 is maintained on distributed ledger 216 allowing various data specific to the plurality of slots to be accessible once one or more transactions reached the applicable identifiable stage. It is to be understood that the purpose of the communication modules are to scalably ensure passage of data between first subscriber 112 and second subscriber 116 during communicative sessions at the proper identifiable stage of a transaction.

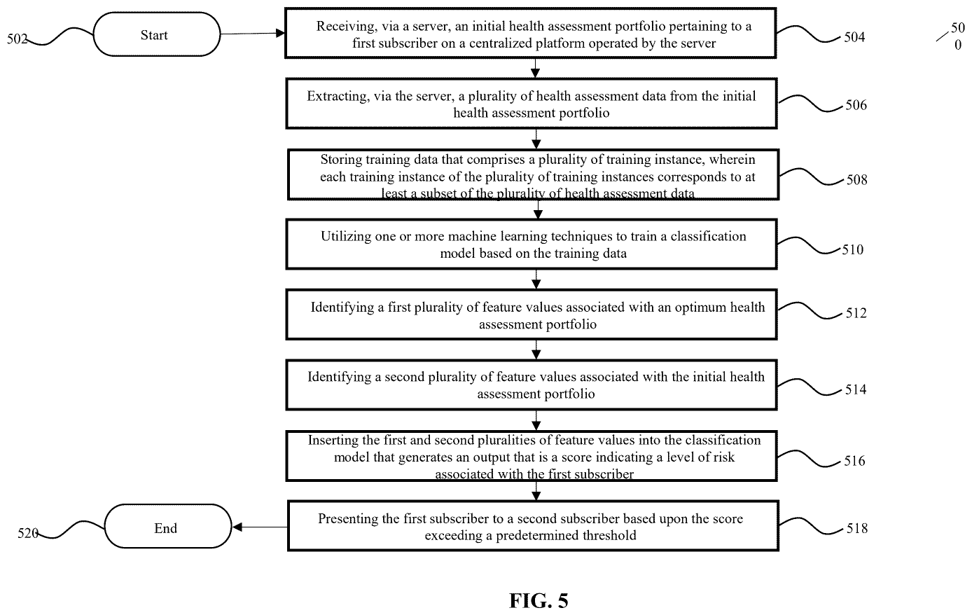

Referring now to FIG. 5, a method for optimizing due diligence 500 is depicted, according to an exemplary embodiment. At step 502, the process begins in which server 102 generates the centralized platform configured to be accessed by first subscriber 112 and second subscriber 116. At step 504, server 102 receives an initial health assessment landscape pertaining to first subscriber 112 on the centralized platform. At step 506, server 102 extracts a plurality of health assessment data from the initial health assessment landscape associated with first subscriber 112. At step 508, server 102 instructs due diligence module 108 to store training data including a plurality of training instances, wherein each training instance of the plurality of training instances corresponds to at least a subset of the plurality of health assessment data. At step 510, machine learning module 202 utilizes one or more machine learning techniques to train a classification model based on the training data. At step 512, machine learning module 202 identifies a first plurality of feature values associated with an optimum health assessment landscape. At step 514, machine learning module 202 identifies a second plurality of feature values associated with the initial health assessment landscape. At step 516, machine learning module 202 inserts the first and second feature values into the classification model that generates output 320. At step 520, the process ends.

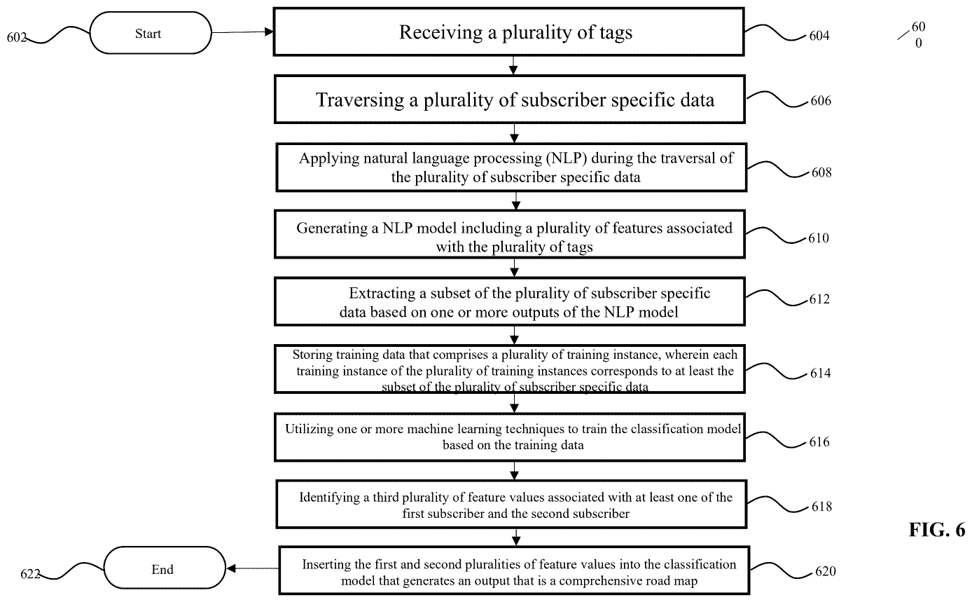

Referring now to FIG. 6, a method for a due diligence analysis 600 rendered by due diligence module 108 is depicted, according to an exemplary embodiment. At step 602, the process starts in which due diligence module 108 has received the plurality of objective data and the plurality of subscriber specific data. At step 604, due diligence module 108 receives a plurality of tags. It is to be understood that the plurality of tags are configured to be utilized by due diligence module 108 in order to proper identify relevant and applicable data within the plurality of objective data and the plurality of subscriber specific data for one or more transactions on the centralized platform. At step 606, due diligence module 108 traverses the plurality of subscriber specific data. At step 608, due diligence module 108 applies natural language processing (NLP) during the traversal of the plurality of subscriber specific data. At step 610, due diligence module 108 generates a NLP model including a plurality of features associated with the plurality of tags. At step 612, due diligence module 108 extracts a subset of the plurality of subscriber specific data based on one or more outputs of the NLP model. At step 614, machine learning module 202 stores training data that comprises a plurality of training instance, wherein each training instance of the plurality of training instances corresponds to at least the subset of the plurality of subscriber specific data. At step 616, machine learning module 202 utilizes one or more machine learning techniques to train the classification model based on the training data. At step 618, due diligence module 108 identifies a third plurality of feature values associated with at least one of first subscriber 112 and second subscriber 116. At step 620, machine learning module 202 inserts the first and second pluralities of feature values into the classification model that generates an output that is a comprehensive road map. In some embodiments, due diligence module 108 receives a plurality of subject matter expert opinions; identifies a fourth plurality of feature values associated with at least the plurality of subject matter expert opinions; and machine learning module 202 inserts the fourth plurality of feature values into the classification model that generates an output score indicating a level of risk associated with at least one of first subscriber 112 and second subscriber 116.

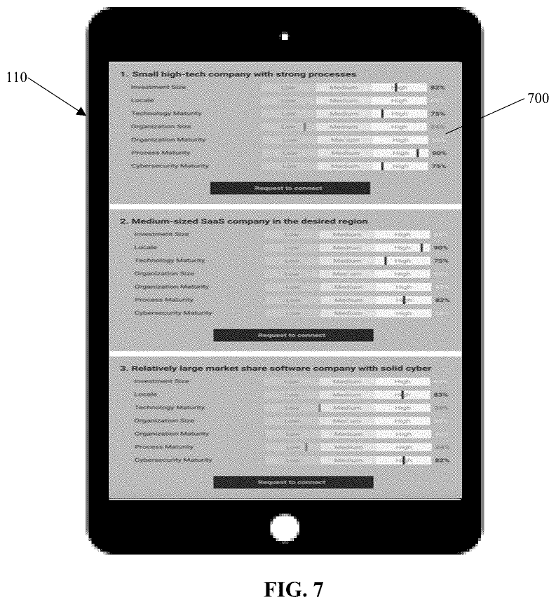

Referring now to FIG. 7, a user interface 700 is depicted on computing device 110, according to an exemplary embodiment. It is to be understood that the user interface generated by server 102 to be presented on the centralized platform are designed and configured to be interactive with at least one of first subscriber 112 and second subscriber 116 via computing devices 110 and 114. User interface 700 is configured to receive inputs from the applicable subscriber and in some embodiments inputs from the applicable subscriber are received in response to prompts from at least one of server 102, due diligence module 108, subject matter experts, and/or assessment areas 300.

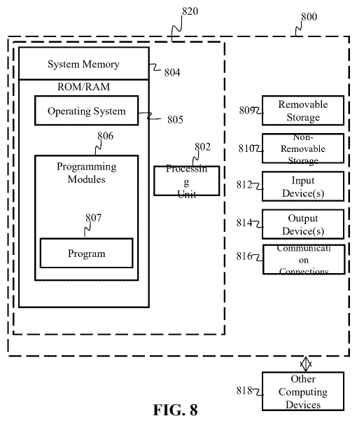

FIG. 8 is a block diagram of a system including an example computing device 800 and other computing devices. Consistent with the embodiments described herein, the aforementioned actions performed by server 102 may be implemented in a computing device, such as the computing device 800 of FIG. 8. Any suitable combination of hardware, software, or firmware may be used to implement the computing device 800. The aforementioned system, device, servers, and processors are examples and other systems, devices, and servers may comprise the aforementioned computing device. Furthermore, computing device 800 may comprise an operating environment for server 102 and processes/methods 500 & 600. Processes 50 and 600, and data related to said processes may operate in other environments and are not limited to computing device 800.

In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination or memory. System memory 804 may include operating system 805, and one or more programming modules 806. Operating system 805, for example, may be suitable for controlling computing device 800's operation. In one embodiment, programming modules 806 may include, for example, a program module 807 for executing the actions of server 102, for example. Furthermore, embodiments of the invention may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 806 and a non-removable storage 810. Computer storage media may include volatile and nonvolatile, removable and non-removable media implemented in any method or technology for storage of information, such as computer readable instructions, data structures, program modules, or other data. System memory 804, removable storage 806, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a camera, a touch input device, etc. Output device(s) 814 such as a display, speakers, a printer, etc. may also be included. The aforementioned devices are only examples, and other devices may be added or substituted.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 804, including operating system 805. While executing on processing unit 802, programming modules 806 (e.g. program module 807) may perform processes including, for example, one or more of the stages of the processes 500 and 600 as described above. The aforementioned processes are examples, and processing unit 802 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Referring now to FIG. 9, which shows a block diagram of a due diligence system 900 which incorporates an exemplary dynamic vector-guided depth-limited graph traversal module integrated into the due diligence module of FIG. 2, for reducing computational resource usage in carrying a due diligence inquiry, according to an example embodiment. In particular, the system is used to acquire due diligence information using questionnaires and/or surveys that are based on a question tree or graph structure. A server 902 is coupled to a database 904 in which one or more question trees 906 are stored. The server is operably coupled to a network 914 so as to be in communication with a remote client computer 912. The client computer 912 is used by a person to view, and respond to questions provided by the server 902 from the database 904. Initially a first question is provided, such as, for example, an identifier of the person (e.g. name, employee number, etc.). In fact there is likely a common initial set of questions that need to be answered. As the question tree is traversed, at some point, it will become inefficient to traverse the question tree 906 using prior art methods. Instead, the server 902 can provide a neural scoping function - a machine learning or artificial intelligence agent that evaluates the answer to determine whether to continue traversing the tree linearly or whether it is appropriate to jump to another portion 908 of the tree. When it is decided to jump to a new portion 908, that portion 908 is pruned from the tree and can be sent to and processed by the remote client machine 912 via the network 914. Or, alternatively, the server 902 can, through an interface (e.g. browser window at client machine 912) present the questions of the portion 908 and receive the answers from the user of the client machine 912.

In some embodiments, system 900 includes components for receiving natural language query inputs, generating query embedding vectors using trained neural language models (e.g., sentence-transformers/all-MiniLM-L6-v2 with at least 384 dimensions), retrieving node embeddings from a hierarchical graph database indexed using Hierarchical Navigable Small World (HNSW) data structures (with M=16 bidirectional links per layer and ef_construction=200), computing similarity scores via cosine similarity with single instruction multiple data (SIMD) instructions for parallel operations and early termination, determining dynamic traversal depth thresholds using formulas such as:

$$D = min ( D max , ⌈ {log}_{2} ( \sum ( similarity\_scores > θ ) ⋆ \vert V \vert / baseline\_nodes ) ⌉ )$$

### Where:

D is the calculated traversal depth - how many layers deep into the graph to go.
Dmax is predefined maximum depth, used as a safety net.
θ defaults to 0.7
   |V| is the total number of vertices.
   The new tree segment or portion can be identified by executing bounded traversals with lazy loading (cursor-based streaming, batch size 256) and pruning (similarity<θ), pre-warming CPU cache with top-K similar nodes (K=min(256, D*average_branching_factor)) using prefetch instructions, and returning results in a single network response. The “all-MiniLM-L6-v2” is a pre-trained machine learning model that is designed to encode sentences and short paragraphs into semantically meaningful, fixed-size vector representations (embeddings) that capture their meaning, making it useful for tasks like semantic search, clustering, paraphrase detection, and information retrieval. As used here, M specifies the maximum number of bidirectional connections (edges or “links”) each node (vector embedding) can have in a given layer of the HNSW graph. With M=16, as an example, during index construction, the algorithm aims to connect each node to up to 16 of its closest neighbors per layer, creating a navigable network. “Bidirectional” means the links are mutual (A links to B implies B links to A), though implementations may store them directed for efficiency. This controls the graph's density and “small-world” properties—higher M increases connectivity for better search accuracy (higher recall) but raises memory usage and build time. M=16 is a balanced default in some embodiments, providing good recall without excessive overhead, especially for medium-sized datasets like 10M-node due diligence graphs. Setting “ef_construction” to 200 defines the number of candidate neighbors explored when inserting a new vector into the index. With ef_construction=200, the algorithm evaluates up to 200 potential connections per layer during greedy searches for each insertion, selecting the best M (e.g., 16) for actual links. Higher values improve index quality (better approximation of true nearest neighbors) by diversifying connections and reducing local minima, but at the cost of slower construction (proportional to ef_construction). Setting ef_construction=200 provides 5-10% better recall compared to lower values (e.g., 100). The “average_branching_factor” indicates a statistical measure of the hierarchical graph structure (e.g., the question tree in a due diligence database). It represents the average number of outgoing edges, branches, or child nodes per vertex (node) in the graph—essentially quantifying how “branchy” or expansive the tree is on average across its levels. The operation of monitoring question responses, and calculating a more relevant segment of the total question tree for presentment to the client machine reduces CPU cycles by at least 85%, memory usage by 70%, and disk I/O by 60% compared to full-depth traversal, as is conventional.

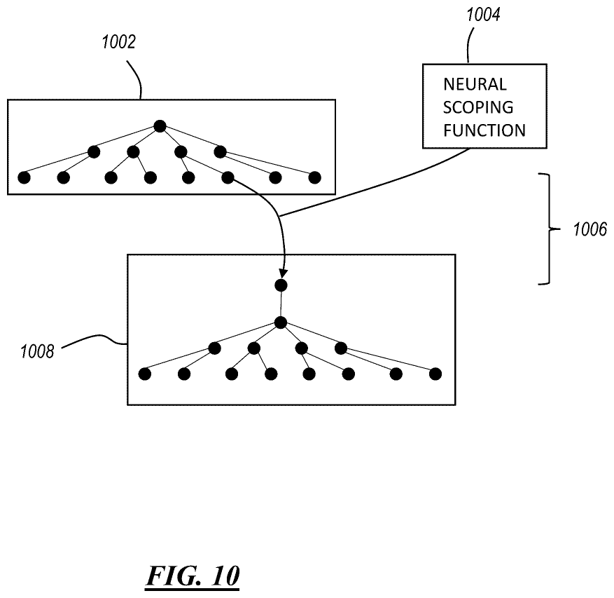

Referring now to FIG. 10, shows an example of a dynamic depth calculation in a question tree traversal in which a neural scoping function 1004 determines a new starting location in the question tree based on the relevancy of a response in order to reduce computational loading, in accordance with some embodiments. The total question tree is not represented here, as it can have a very large number of nodes. Rather two different portions 1002, 1008 are shown. Portion 1002 represents a first portion of the total question tree which is presented to a person to acquire due diligence information. The node of the first portion 1002 are traversed in a routine manner, but the answers provided are monitored by a neural scoping function 1004 that can evaluate the responses and determine when it is appropriate to jump to a new, second portion 1008 of the question tree rather than continue traversing the question tree normally in the first portion 1002. The neural scoping function 1004 is carried out at the server as information is received and processed into vector embeddings. The neural scoping function can be a machine learning engine that is trained to carry out the new tree segment using the calculation discussed in regard to FIG. 9, which will indicate the depth 1006, and identify a new starting node for the tree segment 1008.

a flowchart depicting an exemplary method 1000 for dynamic vector-guided depth-limited graph traversal in due diligence sessions is depicted, according to an example embodiment. At step 1002, receive a natural language query input. At step 1004, generate a query embedding vector using a trained neural language model. At step 1006, retrieve node embeddings from the graph database using HNSW indexing. At step 1008, compute similarity scores between the query embedding and node embeddings. At step 1010, determine a dynamic traversal depth threshold based on similarity distribution. At step 1012, pre-warm CPU cache with top similar node identifiers. At step 1014, execute bounded graph traversal with lazy loading and pruning. At step 1016, return query results through a single network response.

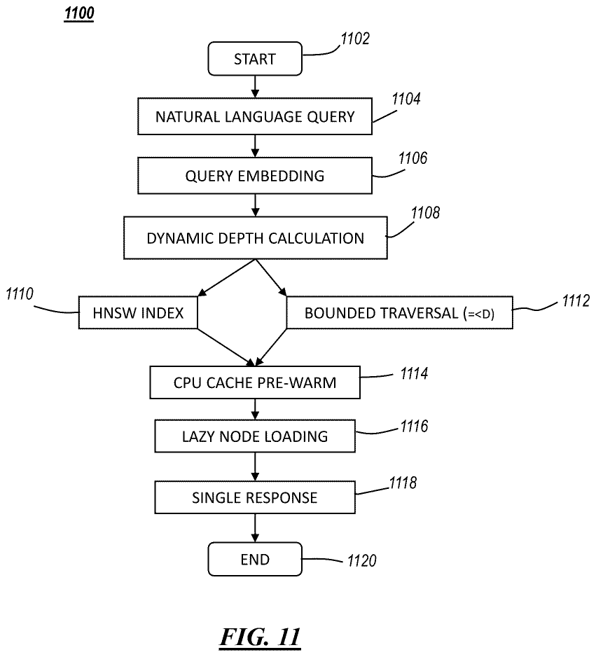

FIG. 11 shows method 1100 of carrying out a dynamic depth operation in the traversal of a large node numbered question tree of a due diligence system, in accordance with some embodiments. At the start 1102 the due diligence platform is operating and has initiated, specifically, a questionnaire or survey, which has been served to a remote machine for a person to provide answers/information in response to the questions being asked. Step 1104 is the initial input stage where the system receives a query response from the user or remote client in natural language form. It serves as the entry point for the workflow, capturing unstructured text that may include context from due diligence scenarios, session history, or user answers. The query response is processed by one or more processors at the server via a network interface, validated for format (e.g., ensuring it's text-based and within length limits), and prepared for semantic encoding. This involves an HTTP request (e.g., POST to/query), with optional parameters like transaction type or prior answers to refine relevance. This step initiates the single-pass execution, consuming minimal resources and setting the foundation for adaptive traversal by providing raw input for embedding generation.

In step 1106 the natural language query response of step 1104 is transformed into a dense vector representation using a trained neural language model (e.g., sentence-transformers/all-MiniLM-L6-v2, producing a 384-dimensional normalized vector). This encoding captures semantic meaning, context, and nuances. The embedding may be refined by fusing with answer vectors (e.g., via averaging or concatenation). The process leverages SIMD-accelerated computations for efficiency and outputs a vector suitable for similarity comparisons. This step enables relevance-driven optimizations downstream, distinguishing from keyword-based systems by allowing mathematical handling of intent, with fallback support for models like BERT variants.

Step 1108 computes the adaptive traversal depth threshold D using the query embedding from step 1106 and similarity scores against graph node embeddings. The formula applied is:

$$D = min ( D max , ⌈ {log}_{2} ( \sum ( similarity\_scores > θ ) ⋆ \vert V \vert / baseline\_nodes ) ⌉ )$$

### Where:

θ is a similarity threshold (e.g., 0.7),
   |V| is total graph vertices, and
baseline_nodes is an empirical constant.
   It counts nodes exceeding θ (via cosine similarity), scales by graph size, normalizes, applies logarithmic transformation for controlled growth, ceilings to an integer, and caps at Dmax (e.g., 10). This step incorporates an average_branching_factor for prediction and may adapt via feedback (e.g., adjusting θ based on prior metrics). It ensures efficient bounding, prioritizing deeper exploration for high-relevance queries while pruning others, achieving O(log N) scaling and preventing resource waste.

Step 1110 involves the HNSW data structure for indexing and retrieving node embeddings from the graph database. Configured with parameters like M=16 bidirectional links per layer and ef_construction=200, it enables an approximate nearest neighbor (ANN) search in O(log N) time. The query vector from step 1106 is used to fetch top-K candidates (e.g., 1000 similar nodes), leveraging multi-layered graphs for coarse-to-fine navigation. Step 1110 integrates with step 1108′s depth calculation by providing similarity distributions and supports dynamic tuning (e.g., ef_search adaptation). This index handles hierarchical structures like question trees, reducing retrieval overhead compared to linear scans and feeding into traversal for pruning low-similarity nodes (<θ).

In step 1112 the system performs a depth-limited graph traversal using the depth D from step 1108, starting from high-similarity nodes retrieved via the HNSW index in step 1110. It explores edges only up to depth≤D, prunes vertices with similarity scores<θ, and applies lazy evaluation to avoid full graph loading. The traversal uses single-pass execution, incorporating predictive elements like average_branching_factor to estimate scope. This step supports skipping irrelevant subtrees if deeper paths show higher relevance, monitoring metrics for feedback (e.g., coverage ratio). This step materializes results while maintaining bounds, reducing CPU usage by 85% compared to conventional tree traversal, and enables anomaly detection in high-value paths.

In step 1114, the system proactively loads metadata for top-K similar nodes (e.g., K=min(256, D*average_branching_factor)) into CPU cache lines prior to full traversal. Nodes are sorted by descending similarity scores, and prefetch instructions (e.g., SIMD-enabled) copy data to L2 cache, ensuring cache coherency via versioned identifiers. Executed after depth calculation, this step anticipates traversal needs from steps 1110-1112, reducing cache misses by 35-40% and time-to-peak memory is reduced (e.g., from 200 ms to 75 ms). This step enhances performance in hierarchical queries by preparing for bounded exploration, particularly in remote client scenarios where latency is critical, without overloading memory.

Step 1116 implements memory-efficient node materialization during traversal, loading only visited nodes on-demand via cursor-based streaming (e.g., batches of 256 nodes) and predictive caching based on traversal predictions. It allocates memory pools sized to expected needs (from D and branching factor), aggressively garbage-collects low-similarity nodes (<0.5) and integrates with database backends. Since this step occurs post-pre-warming, it defers I/O operations, reducing disk accesses by 70% (e.g., 1,416 vs. 4,721 operations) and peak memory use by 70% (5.4 GB vs. 18.3 GB). This step supports dynamic skipping by avoiding unnecessary loads, ensuring scalability for large datasets like 10 M-node hierarchies.

In step 1118, the final output block compiles traversal results into a unified network response, eliminating multiple round-trips (˜0 ms additional latency vs. 250 ms in prior art). It optimizes the response (e.g., via serialization of relevant nodes/questions), incorporates any batched questions or anomaly flags, and returns through the network interface. The output is a second tree portion (e.g. 908, 1008) This step concludes the workflow, providing query completeness while adhering to performance gains (e.g., 312 ms total time). In adaptive contexts, it may include metadata for future sessions, enhancing usability in due diligence applications by delivering concise, actionable insights in one pass. Then the method 1100 ends in 1120.

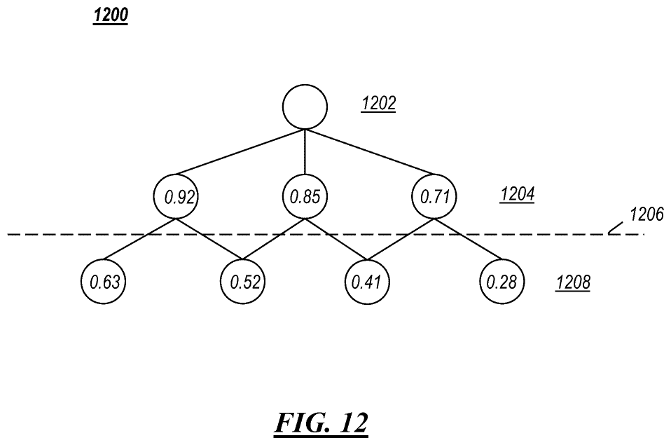

FIG. 12 shows an example 1200 of a dynamic bounding used in traversing a large node number graph, in accordance with some embodiments. For clarity, only a small number of nodes is shown here. A query node level 1202 is shown above a level-1 layer 1204 of several nodes that have high relevancy (0.92, 0.85, 0.71) based on the vector embedding resulting from the query node 1202. A dynamic cutoff 1206 of D=2 is shown, and nodes at a second layer 1208 all have relevancy below the cutoff. The cutoff uses the depth formula. D dynamically adjusts using logarithmic scaling of relevant nodes, graph size, and a baseline constant. In this example, a D=2 requires high similarity. This figure demonstrates the system's vector-guided optimization: Query embeddings (via models like sentence-transformers/all-MiniLM-L6-v2) compute similarities via HNSW-retrieved candidates, feeding the formula to bound traversal. It enables features like anomaly detection by prioritizing “high-value” paths (e.g., deeper if similarities warrant), reducing exponential degradation in large graphs (e.g., 10 M nodes) and achieving O(log N) performance. This is in contrast with the prior art where static depths either miss critical info (too shallow) or waste resources (too deep). The dynamic adaptation reduces loaded nodes by 77%, enabling real-time applications in due diligence (e.g., skipping low-risk branches), reducing use of resources (RAM), and reducing latency.

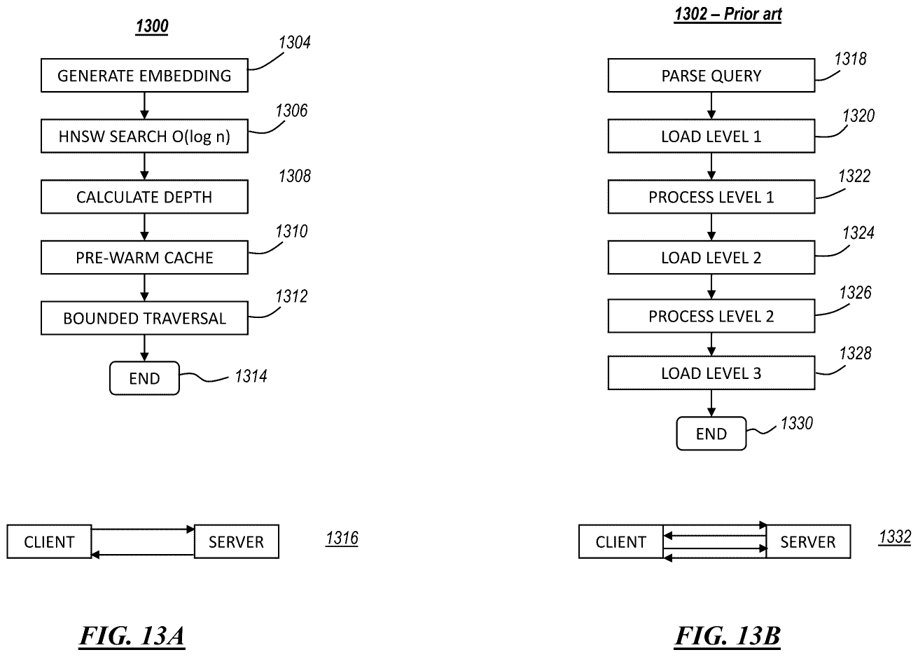

FIGS. 13A and 13B compare the dynamic depth operation with a prior art system, indicating the difference in time and resource usage. In method 1300 of the present disclosure, there is shown a streamlined server-side process starting from “Generate Embedding” (1304), followed by “HNSW Search O(log n)” (1306), “Calculate Depth” (1308), “Pre-Warm Cache” (1310), “Bounded Traversal” (1312), and “End” (1314). At the bottom (1316), a single arrow between “Client” and “Server” illustrates one network exchange. This indicates the vector-guided system: A natural language query from the client triggers embedding generation 1304, then in step 1306 HNSW for similarity retrieval, in step 1308 dynamic D calculation, in step 1310 cache optimization, and in step 1312 bounded traversal with lazy loading—all on the server in one pass, returning results efficiently. This enables resource savings (e.g., 85% CPU reduction) and real-time adaptation for due diligence, avoiding latency from iterative loads.

For contrast, FIG. 13B shows the prior art method 1302 in which there is a repetitive sequence: “Parse Query” (1318), “Load Level 1” (1320), “Process Level 1” (1322), “Load Level 2” (1324), “Process Level 2” (1326), “Load Level 3” (1328), and “End” (1330). The bottom (1332) depicts multiple arrows between “Client” and “Server,” symbolizing repeated round-trips. This represents conventional static traversal: Each level requires separate database loads and processing, leading to high latency (˜250 ms added from RTTs) and resource waste (e.g., full hierarchy loading). The invention improves this by consolidating steps via vector similarity and HNSW for single-response delivery.

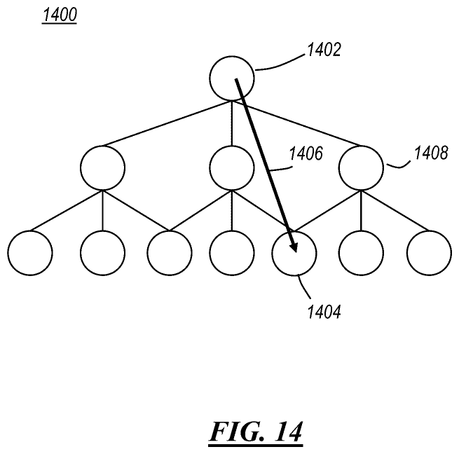

FIG. 14 shows a vector search operation 1400 for dynamic depth when traversing a large number node graph, in accordance with some embodiments. More specifically, FIG. 14 shows a schematic illustration of a hierarchical graph structure representing the question hierarchy in the graph database. In general, there is shown a centralized root node 1402 at the top, branching asymmetrically downward to demonstrate variable depth and branching factor in a typical due diligence graph. The root node 1402 represents the entry point for queries (e.g., a top-level question or query embedding). It connects via a downward arrow 1406 to a central child node 1404, symbolizing the start of bounded traversal, skipping nodes of a first level 1408 and proceeding directly to a second level node 1404 as a result of the bounded traversal operation. retrieved via HNSW (e.g., for cosine scores>θ). Thus, FIG. 14 exemplifies the graph for vector-guided depth-limited traversal: Embeddings are computed for nodes, HNSW enables O(log N) search, and dynamic D (from the formula) bounds exploration to relevant branches (e.g., skipping low-similarity subtrees like unused leaves). It supports lazy loading and cache pre-warming by showing sparse, variable density, enabling 77% node reduction vs. static methods.

The present invention provides a specific improvement to computer functionality by reducing computational resources required for hierarchical graph database queries. The claimed method transforms abstract similarity scores into concrete traversal boundaries that produce measurable improvements in CPU utilization (85% reduction), memory consumption (70% reduction), and I/O operations (60% reduction). These improvements result from the novel combination of vector similarity assessment with dynamic depth calculation, representing a technical solution to a technical problem inherent in graph database systems.

The claims appended hereto are meant to cover all modifications and changes within the scope and spirit of the present invention.

What is claimed is:

1. A method for due diligence optimization comprising:
receiving, via a server, an initial health assessment landscape pertaining to a first subscriber on a centralized platform operated by the server;
extracting, via the server, a plurality of health assessment data from the initial health assessment landscape, wherein extracting includes:
receiving a natural language query input pertaining to the initial health assessment landscape;
generating a query embedding vector using a trained neural language model;
retrieving from a graph database node embeddings representing vertices in a hierarchical question structure;
computing similarity scores between the query embedding and node embeddings using cosine similarity calculation;
determining a dynamic traversal depth threshold D;
pre-warming CPU cache lines with metadata for top-K similar nodes, where K is determined based on D and an average branching factor;
executing a bounded graph traversal limited to depth≤D, with lazy node loading using cursor-based streaming, to extract the plurality of health assessment data; and
returning results in a single network response to extract further health assessment data via further natural language query input that is responsive to the results;
storing training data that comprises a plurality of training instances, wherein each training instance of the plurality of training instances corresponds to at least a subset of the plurality of health assessment data;
utilizing one or more machine learning techniques to train a classification model based on the training data;
identifying a first plurality of feature values associated with an optimum health assessment landscape;
identifying a second plurality of feature values associated with the initial health assessment landscape;
inserting the first and second pluralities of feature values into the classification model that generates an output that is a score indicating a level of risk associated with the first subscriber; and
presenting the first subscriber to a second subscriber based upon the score exceeding a predetermined threshold.

2. The method of claim 1, wherein said vector comprises at least 384 dimensions.

3. The method of claim 1, wherein the dynamic depth threshold D is calculated using the formula:
$$D = min ( D max , ⌈ {log}_{2} ( \sum ( similarity\_scores > θ ) ⋆ \vert V \vert / baseline\_nodes ) ⌉ )$$
where:
Dmax is a system-defined maximum depth,
θ is a similarity threshold,

|V| is total graph vertices,
baseline_nodes is an empirically determined constant.

4. The method of claim 1, wherein the node embeddings are indexed using Hierarchical Navigable Small World (HNSW) data structures configured with M=16 bidirectional links per layer and ef_construction=200 for index building.

5. The method of claim 1, wherein executing the bounded graph traversal further comprises pruning nodes with similarity scores below the similarity threshold θ during traversal to reduce computational resource usage.

6. The method of claim 1, wherein the lazy node loading uses batch sizes of 256 nodes and employs cursor-based streaming to avoid loading the entire hierarchical question structure into memory.

7. The method of claim 1, wherein pre-warming the CPU cache lines uses single instruction multiple data (SIMD) prefetch instructions to load metadata for the top-K similar nodes, reducing cache misses by at least 35%.

8. The method of claim 1, further comprising: receiving a plurality of subject matter expert opinions; identifying a fourth plurality of feature values associated with the plurality of subject matter expert opinions; and inserting the fourth plurality of feature values into the classification model to refine the score indicating the level of risk.

9. The method of claim 1, wherein the centralized platform includes a security module with a distributed ledger configured to monitor and record access to sensitive data extracted from the initial health assessment landscape, using proof-of-collaboration consensus mechanisms.

10. The method of claim 1, further comprising: storing the extracted plurality of health assessment data in an evidence virtual data room with timestamping and two-layer storage functionality to ensure data privacy and granular access control.

11. A system for due diligence optimization with adaptive resource management, comprising:
a server communicatively coupled to a database storing a hierarchical question structure represented as a graph;
a due diligence module executed by the server and configured to:
receive an initial health assessment landscape pertaining to a first subscriber on a centralized platform operated by the server;
extract a plurality of health assessment data from the initial health assessment landscape by:
receiving a natural language query input pertaining to the initial health assessment landscape;
generating a query embedding vector using a trained neural language model;
retrieving from the graph database node embeddings representing vertices in the hierarchical question structure, the node embeddings indexed using Hierarchical Navigable Small World (HNSW) data structures;
computing similarity scores between the query embedding and node embeddings using cosine similarity calculation; determining a dynamic traversal depth threshold D;
pre-warming CPU cache lines with metadata for top-K similar nodes, where K is determined based on D and an average branching factor;
executing a bounded graph traversal limited to depth≤D, with lazy node loading using cursor-based streaming, to extract the plurality of health assessment data; and
returning results in a single network response to extract further health assessment data via further natural language query input that is responsive to the results;
a machine learning module communicatively coupled to the due diligence module and configured to:
store training data comprising a plurality of training instances, wherein each training instance corresponds to at least a subset of the plurality of health assessment data;
utilize one or more machine learning techniques to train a classification model based on the training data;
identify a first plurality of feature values associated with an optimum health assessment landscape;
identify a second plurality of feature values associated with the initial health assessment landscape;
insert the first and second pluralities of feature values into the classification model to generate an output that is a score indicating a level of risk associated with the first subscriber; and
present the first subscriber to a second subscriber based upon the score exceeding a predetermined threshold.

12. The system of claim 11, wherein the machine learning module further includes: a training data module for dynamically updating the training data; an update module for periodically replacing the classification model with a new model based on updated training data; and a prediction module for generating real-time risk scores.

13. The system of claim 11, further comprising a reputation module configured to: perform domain inspection, background checks, web crawling, and network evaluation on the first subscriber; and generate reputation data integrated into the plurality of health assessment data.

14. The system of claim 11, further comprising a communication module integrated with the security module, the communication module configured to facilitate secure exchanges between the first subscriber and the second subscriber using the distributed ledger to prevent unauthorized data downloads.

15. The system of claim 11, wherein the due diligence module is further configured to integrate a neural scoping function that evaluates responses during graph traversal to dynamically select a new starting node in the hierarchical question structure, reducing memory usage by at least 70%.

16. The system of claim 11, wherein the bounded graph traversal reduces CPU cycles by at least 85% compared to full-depth traversal of the hierarchical question structure.

17. The method of claim 1, further comprising: receiving a plurality of tags associated with subscriber-specific data; traversing a plurality of subscriber-specific data using natural language processing (NLP); generating an NLP model including a plurality of features associated with the plurality of tags; extracting a subset of the plurality of subscriber-specific data based on outputs of the NLP model; and integrating the subset into the training data for the classification model.

18. The method of claim 17, further comprising: identifying a third plurality of feature values associated with at least one of the first subscriber and the second subscriber; and inserting the third plurality of feature values into the classification model to generate an output that is a comprehensive roadmap for risk reduction.

19. The method of claim 1, wherein the trained neural language model is a sentence-transformers/all-MiniLM-L6-v2 model, and the query embedding vector is fused with prior response vectors via averaging or concatenation to refine relevance.

20. A method for due diligence analysis in a centralized platform, comprising:
receiving, via a server, a plurality of objective data and a plurality of subscriber-specific data associated with a first subscriber;
receiving a plurality of tags for identifying relevant data; traversing the plurality of subscriber-specific data while applying natural language processing (NLP);
generating an NLP model including a plurality of features associated with the plurality of tags;
extracting a subset of the plurality of subscriber-specific data based on one or more outputs of the NLP model;
storing training data comprising a plurality of training instances, wherein each training instance corresponds to at least the subset of the plurality of subscriber-specific data;
utilizing one or more machine learning techniques to train a classification model based on the training data;
identifying a first plurality of feature values associated with an optimum health assessment landscape;
identifying a second plurality of feature values associated with an initial health assessment landscape of the first subscriber;
identifying a third plurality of feature values associated with at least one of the first subscriber and a second subscriber;
inserting the first, second, and third pluralities of feature values into the classification model to generate an output that is a comprehensive roadmap for transactional risk reduction; and
presenting the comprehensive roadmap to the first subscriber and the second subscriber via the centralized platform.
